(19) United States
(12) Patent Application Publication
(10) Pub. No.: US 2004/0250961 A1
(43) Pub. Date: Dec. 16, 2004

(54) Hand-held device for applying a film of adhesive, covering or colored material onto a substrate

(76) Inventor: Franck Rolion, Belloy en France (FR)

Correspondence Address: JONES DAY, 222 EAST 41ST ST, NEW YORK, NY, 10017, US

(21) Appl. No.: 10/803,463

(22) Filed: Mar. 18, 2004

Related U.S. Application Data
(63) Continuation of application No. PCT/EP02/07965, filed on Jul. 17, 2002.

(30) Foreign Application Priority Data
Sep. 19, 2001 (EP) EP 01 122 365.8

(51) Int. Cl. B32B 31/00

(52) U.S. Cl. 156/577; 156/574; 156/579

(57) ABSTRACT

The invention relates to a hand-held device for transferring a film of, for example, adhesive, covering, or colored material onto a substrate. The device has a housing accommodating a film supply and an application member longitudinally projecting from the housing. Film extends from the supply at the lower longitudinal side of the application member facing the substrate during the mode of operation to an application edge of the application member running transversely at the front end. The application member is composed of two application member portions movable relative to each other. In order to enhance the movability of the hand-held device, the relative movement is limited by motion stops provided as an integral part at the application member portions.

### CROSS-REFERENCE TO RELATED APPLICATION

This application is a continuation of PCT Application No. PCT/EP02/07965, filed on Jul. 17, 2002, which claims priority to European Patent Application 01 122 365.8, filed on Sep. 19, 2001. The entire contents of these two applications is expressly incorporated herein by reference.

### FIELD OF THE INVENTION

The present invention relates to a hand-held device for applying a film of adhesive, covering, or colored material onto a substrate, the device having an application member or tip with a movable portion.

### BACKGROUND OF THE INVENTION

A hand-held device of this type is described in U.S. Pat. No. 5,772,840, corresponding to EP 0 719 723 B1. In this previously known hand-held device, a longish application member is supported to be pivotable around its longitudinal axis and is centered in the middle by spring forces with respect to pivotable movements opposing each other. Thereby, the application member can adapt to the substrate by means of rotation in case that the application member is placed on the substrate in an oblique fashion. In the absence of pressure, the application member turns automatically into its rotational central position due to the present restoring elastic force. In addition, the application member comprises in its longitudinal portion extending outside the housing of the hand-held device guiding webs protruding upwards and downwards at both sides, between which a backing tape carrying the film is guided. In front of the guiding webs, the application member has a cross-sectional reduction on both sides in the form of lateral recesses. The purpose of said cross-sectional reduction is not described.

Another hand-held with a movable application member can also be derived from U.S. Pat. No. 4,851,076, corresponding to DE 3 638 722 A. The longish application member of this patent comprises a cross-sectional reduction in the form of the body of a wasp in addition to its elastically yielding arrangement. Thereby, the front portion of the application member is elastically bendable in a transverse direction and suspended in a pendulous fashion.

What can be derived from U.S. Pat. No. 4,853,074, corresponding to EP 0 313 719 B1, is a hand-held device whose application member is movable upwards from a lower starting position against an elastic spring force against a stop at the housing. Thereby, the application member is resilient to the top by the pressure effective in this case when the application member is placed onto the substrate, and it is spring-mounted against sudden overload.

### SUMMARY OF THE INVENTION

The present invention improves a hand-held device of the type described above with respect to how its movement is carried out and/or to design a handheld device such that it can be manufactured easily and inexpensively. In doing so, a small construction is supposed to be ensured as well. Moreover, the arrangement and mounting of the application member in the housing is supposed to be improved and/or simplified.

In a hand-held device formed in accordance with principles of the present invention, stops acting together are provided at the front and rear portions of the application member. The stops border the relative movement of the front portion during the mode of operation. Thereby, several advantages are achieved. For one, the application member is stabilized by the stops, since the bending stress is reduced when the stop is reached. This is due to the fact that, when the stop is reached, the stops arranged at a, for instance, transverse distance from the center of the bending range of the application member reduce the moments of force effective in the bending range. This can be explained such that bending stresses are effective in the bending range before the stop is reached, while it is primarily tensile stresses that are effective in the bending range when the stop has been reached. Due to the distance of the stops from the center of the bending range, there are reduced stresses in the bending range when the stop has been reached because of the lever principle. In addition, it is possible to manufacture parts of simple and small construction in the configuration according to the invention. This is due to the fact that the invention provides for both stops to be arranged at the application member, so that they can be mounted more easily and in particular as an integral part when manufacturing the application member. As a result thereof, special costs for the manufacture of the stops are not incurred.

It is possible within the framework of the invention to use the stops for limiting a bending movement and/or torsion movement of the front portion. In the former case, the stops are at an axial distance from each other directed towards the longitudinal direction of the application member in the ordinary original position of the front portion. In the latter case, said distance is directed towards the peripheral direction, so that the front portion can carry out a pivotable or torsional movement.

The restoring elastic force is generated by the fact that the application member is composed of an elastically deformable material at least in its bending and/or torsion range. As a result thereof, the elastic restoring force is generated during movement against the stops and is stored in the material, so that it moves the front portion back into its neutral original position after said front portion has been relieved.

Within the framework of the invention, the bending and/or torsion range between the rear and the front portions can be localized by a cross-sectional reduction, which can be provided at the upper side of the application member and/or on both sides or on all sides. By a reduction in cross-section, the bending or torsion moment of resistance in the range of deformation can, for one, be reduced and, for the other, be determined.

It is advantageous to provide the stops in the portion of the application member that extends beyond the housing, not only for reasons of construction, but also for reasons of function. In this case, it is not only that the stops have a larger space available, wherein the housing can be designed to be small and easy-to-use, but there is also a smaller distance between the front end of the application member and the stops during the mode of operation. One result thereof is not only a reduction of the stresses in the application member produced by the movement of the front portion, but the dimension of movement resulting from a movement at the front end of the front portion is desirably small.

When upper and/or lower lateral guiding webs for a backing tape are present, it is particularly advantageous to provide the cross-sectional reduction in the area of the guiding webs. In this case, the guiding web portions can form the stops, without special stops having to be created. In a preferred embodiment, stops are mounted at the application member on top and on the sides, preferably in combination with a cross-sectional reduction. The cross-sectional reductions can be constituted by thin slots, for instance of a width of less than about 2 mm or especially of less than about 1 mm. In this embodiment, the transverse bending movement is small or negligible. The stops form support surfaces for a rotational movement, which favour the torsion movement.

### BRIEF DESCRIPTION OF THE DRAWINGS

In the following, preferred configurations of several exemplary embodiments shall be explained in more detail with the aid of drawings.

FIG. 1 is a side elevational view of an exemplary hand-held device according to the principles of the invention for transferring and/or applying a film of, for example, adhesive, covering or coloured material from a backing tape onto a substrate;

FIG. 2 is an enlarged representation of the front end portion of the hand-held device of FIG. 1;

FIG. 3 is a cross-sectional view cut along line III-III of FIG. 2;

FIG. 4 is a top elevational view of a modified embodiment of an application member of the hand-held device;

FIG. 5 is a perspective side view of a further modified embodiment of an application member;

FIG. 6 is a perspective side view of a further modified embodiment of an application member; and

FIG. 7 is a top elevational view of a further modified embodiment of an application member.

### DETAILED DESCRIPTION OF THE INVENTION

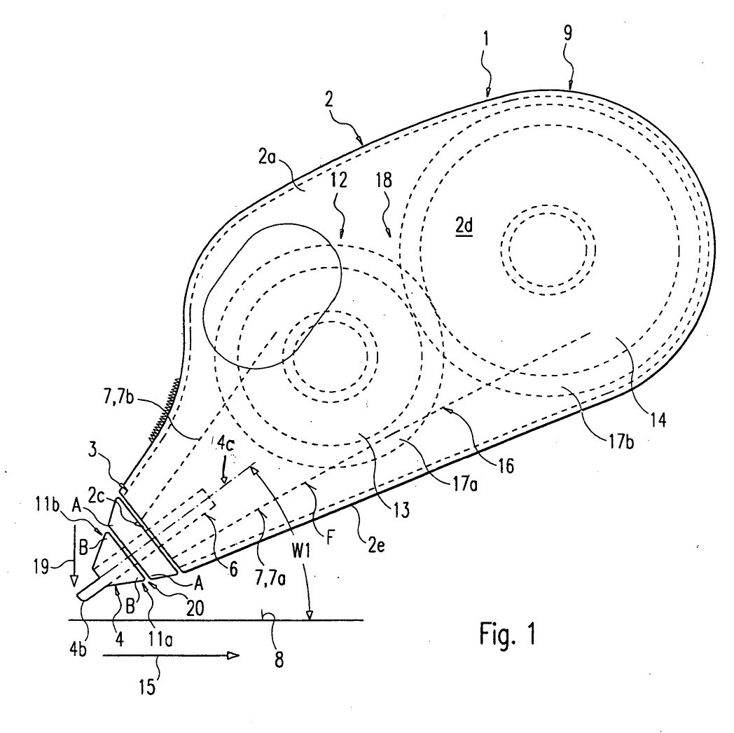

The hand-held device 1, illustrated in FIG. 1, comprises a housing 2 of convenient size, which is formed of two longitudinally or transversely divided housing parts 2a, 2b which can be mounted to each other in a detachable or non-detachable fashion. FIG. 1 shows the hand-held device 1 in its position of operation. The left-hand and lower end of the housing 2 or the hand-held device 1 in FIG. 1 is its working end 3 at which an application member 4 is provided, which projects from the circumference of the housing 2 with an application gib 4a. The application gib 4a, extends in a wedge-shaped convergent fashion towards an application edge 4b, which can be rounded, if necessary. The application member 4 is associated with an application base 6, the application base 6 being mounted to the housing 2 in a detachable fashion in the exemplary embodiment.

The hand-held device 1 serves for transferring a film F of covering and/or colored and/or adhesive material from a film-like backing tape 7 onto a substrate 8, for instance, a sheet of paper. The backing tape 7 extends from a supply located in the cavity of the housing 2 towards the application member 4 in the area of at least one housing aperture 2c, is wound around its application edge 4b, and is refed to the cavity of the housing 2 through the housing aperture 2c. The winding plane is referred to by E1 (see FIG. 4). The backing tape section approaching the application gib 4a at the here lower longitudinal or approach side 1la of the application member 4 is identified by 7a. The backing tape section being refed into the housing 2 at the upper longitudinal or return side 11b of the application member 4 is identified by 7b. The winding plane El extends roughly parallel and preferably mid-centrally to the broad sides 2d of the housing 2, which extend, for instance, parallel to each other, the peripheral surface of the narrow side of the housing 2 being identified by 2e. The returning backing tape portion 7b extends towards a take-up device 12 mounted in the cavity of the housing 2, wherein the take-up device 12 can be a take-up spool 13 which is rotatably mounted in the housing 2. The supply 9, too, can be formed by a spool, namely a supply spool 14 which is rotatably mounted in the housing 2. In the exemplary embodiment, the supply 9 and the take-up device 12 are arranged behind each other, the take-up device 12 being disposed between the supply 9 and the working end 3 of the housing 2.

In the position of operation according to FIG. 1, the application member 4 abuts on the substrate 8 with its application edge 4h, wherein the central axis 4c of the application gib 4d encloses an acute angle W1 with the substrate 8 extending, for instance, to be straight, said angle ranging, for example, between approximately 30° to 60°. By moving the hand-held device 1 in the application direction identified by 15, the backing tape section 7a is peeled off the supply 9 due to the friction at the substrate 8. In doing so, the film F remains on the substrate surface, and the backing tape section 7b is moved into the cavity of the housing 2, here to the take-up device 12. The backing tape section 7b is driven by the backing tape section 7a approaching the application member 4 or its tensile force. In the present exemplary embodiment, this is effected by providing a swivel drive connection 16 between the supply spool 14 and the take-up spool 13, for instance in the form of overlapping rubbing surfaces 17a, 17b at the peripheral edges of the walls of the spools. The winding diameter of the spools 13, 14 is dimensioned to be large enough for the take-up spool 13 to attempt to pull in the backing tape 7, also in the event of a full supply spool 14, at a speed which is higher than the speed at which the backing tape 7 is wound off the supply spool 14. By a slip friction clutch 18 integrated in the swivel drive connection 16, which here is formed by the rubbing surfaces 17a, 17b which are in frictional contact with each other, it is ensured that the take-up spool 13 pulls in the backing tape 7 always at a certain tensile stress, whereby the formation of loops in the backing tape 7 is avoided. The application movement 15 is directed to the end of the housing 2 opposite the working end 3.

In the exemplary embodiment, the application gib 4a has a flat cross-sectional shape whose width a is a multiple of its thickness b, e.g., at a ratio of about 3:1 to 10:1, in particular about 6:1. Due to this cross-sectional shape, the application gib 4a has a relatively high horizontal moment of resistance and a relatively low vertical moment of resistance. As a result thereof, the application gib 4a tends to evade from the pressure force 19 arising during the mode of operation by bending upwards. In order to prevent this and to give guidance to the backing tape 7, lateral guiding webs 21 are provided at least on top of, preferably also at the bottom of, the application gib 4a, between which guiding webs the backing tape 7 is guided with freedom of play and which thus constitute a tape guidance 22. The guiding webs 21 can extend up to the front end of the application gib 4a. In the exemplary embodiment, the guiding webs 21 terminate towards the front at a distance c from the front end of the application gib 4a or its application edge 4b. As far as the back is concerned, the guiding webs 21 extend up to the vicinity of the housing 2, which ends in a plane end surface 2e at the working end 3 in the area of the housing aperture 2c. The rear surfaces 21a of the guiding webs 21 extend approximately parallel and at a small distance to the end surface 2e. In the area of the distance c, at which the application gib 4a extends beyond the guiding webs 21 to the front, the application gib 4a is elastically bendable in a vertical direction under the effect of the pressure force 19, and it is automatically bent back by the elastic restoring force generated when it is bent outwards, as soon as the pressure force 19 is ineffective. Thus, the application gib 4a is cushioned against hard pressure loads in its vertical plane.

In order to ensure that the application gib 4a has the degrees of freedom 23a to 23d illustrated by double arrows in the figures, the application gib 4a has a cross-sectional reduction 20 in the form of a slot 24 or a gap extending at right angles to the central axis 4c. The slot 24 reduces the cross-sectional size of the application gib 4a to a preferably mid-centrally arranged remaining cross-section 25 and thus diminishes the strength of the application gib 4a such that the portion 4e, which is in front with respect to the cross-sectional reduction, can carry out movements relative to the rear portion 4d.

In the area of the cross-sectional reduction 20, the moment of resistance of the application gib 4a is reduced, whereby, due to the elasticity of the material of the application gib 4a prevailing in the area of the remaining cross-section 25, the front gib portion 4e is movable relative to the rear gib portion 4d from its normal rest position and automatically returns into its original position due to the elasticity of material in the range of the remaining cross-section 25 after relief. A cross-sectional reduction 20 on top and/or at the bottom affords swivelling of the front gib portion 4e relative to the rear gib portion 4d in a vertical direction. This first degree of freedom is identified by 23a. If the cross-sectional reduction 20 is at one or on both sides of the application gib 4a, the front gib portion 4e is laterally bendable with respect to the rear gib portion 4d in a horizontal direction against the prevailing elastic restoring force, as identified by 23b. If the material reduction 20 is present on all sides, the front gib portion 4e is pivotable relative to the rear gib portion 4d both vertically and horizontally and is also torsional about the central axis 4c or the remaining cross-section 25, namely also against the elastic restoring force of the remaining cross-section 25, so that, in the absence of a load causing the torsion, the front gib portion 4e is automatically returned into its mid-central original position. Due to this elastic suspension of the front gib portion 4e, the latter is in a position, during the mode of operation of the hand-held device, to adapt to different lateral inclinations of the substrate surface, without the person using the device having to pay special attention to the different inclinations. Thereby, it is not only the pressure of the front gib portion 4e against the substrate, especially its pressure over the surface, that is improved or a pressure over the surface is ensured also in the event of different inclinations of the substrate surface, but also the handling of the hand-held device during the mode of operation is facilitated. The horizontal degree of freedom is identified by 23b, and the degree of torsion freedom by 23c.

There are at least two stops A, B corresponding with each other that are provided for bordering at least one degree of freedom. The stops are associated each with one of the two gib portions 4d, 4e and are integrally formed therewith. Depending on the direction of movement in which degree of freedom is supposed to be bordered by one pair of stops A, B, the latter are to be mounted. In order to border all degrees of freedom by pairs of stops A, B, one pair of stops A, B is required in the upper area of the gib portions 4d, 4e for bordering an upward movement, one pair of stops A, B is required in the lower area of the gib portions 4d, 4e for bordering a downward movement, one pair of stops A, B is required in each lateral area of the gib portions 4d, 4e for bordering the appertaining lateral movement, and one pair of stops A, B is required for bordering a torsion movement 23c.

The dimension of the movement of the degree of freedom depends on the axial distance d of the stops A, B from each other. Thus, the respective movement of the degree of freedom can be specifically dimensioned and limited by the stops A, B. The smaller the axial distance of the stops A, B from each other, the more the stops A, B constitute sliding surfaces for a rotational or torsion joint pivotable about the remaining cross-section 25, with the front gib portion 4e being supported so as to slide at the rear gib portion 4d, whereby not only the torsion movement in a plane of movement running at right angles to the central axis 4c is defined, but also the torsion movement is specifically guided on account of the guidance at the rear gib portion 4d.

The axial width of the cross-sectional reduction 20 or the axial distance d between the stops A, B in the neutral rest position of the front gib portion 4e can be 2 mm or less or also only 1 mm or less for a pitch and/or lateral movement of the front gib portion 4e, depending on the movement required. In the event that only a torsion movement is desired, the axial distance d can correspond to a sliding clearance only and be, e.g., only, a few tenths of a millimeter.

In the exemplary embodiment, the cross-sectional reduction 20 extends preferably in the mid-central longitudinal area transversely through the guiding webs 21, so that their guiding web portions 21a, 21b facing each other constitute support surface 24a, 24b representing the stops A, B. The cross-sectional reduction 20 extends preferably also in the area of the application gib 4a, so that the remaining cross-section 25 has a cross-sectional surface which is smaller than the cross-sectional surface of the application gib 4a. The cross-sectional shape of the remaining cross-section 25 can be e.g., round, as shown in FIG. 3. The vertical dimension of the remaining cross-section 25 can correspond to the vertical dimension of the application gib 4a.

In the exemplary embodiment, the stops A, B are thus mounted at support parts, here at the guiding webs 21, which protrude transversely from the application gib 4a. Leverage lengths e result therefrom, so that a load having the effect of tensile stress is exerted on the remaining cross-section 25 in a vertically or horizontally directed end position of movement and under continued bending stress in the area of the remaining cross-section 25.

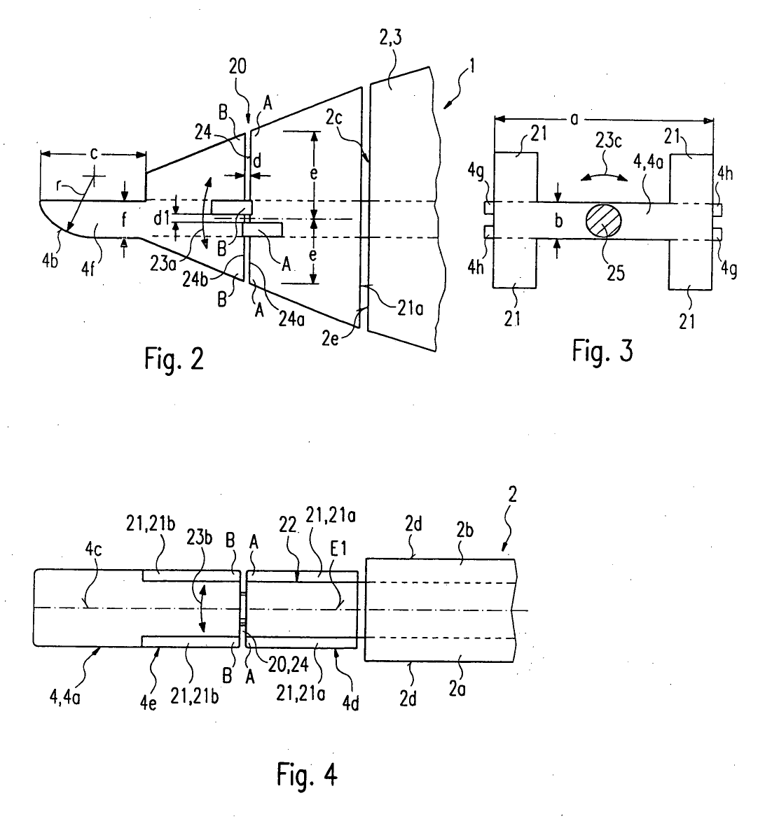

In FIGS. 2 and 3, stops A, B, limiting a torsion movement 23c, are formed at material lugs 4g, 4h, respectively, at the side walls of the rear and front gib portions 4d, 4e, respectively, legs 4g, 4h extend beyond the support surfaces 24a, 24b and overlap each other at the distance d1 directed towards the peripheral direction. The angle of torsion can be, e.g., approximately +/−5°, from the stress-relieved central position.

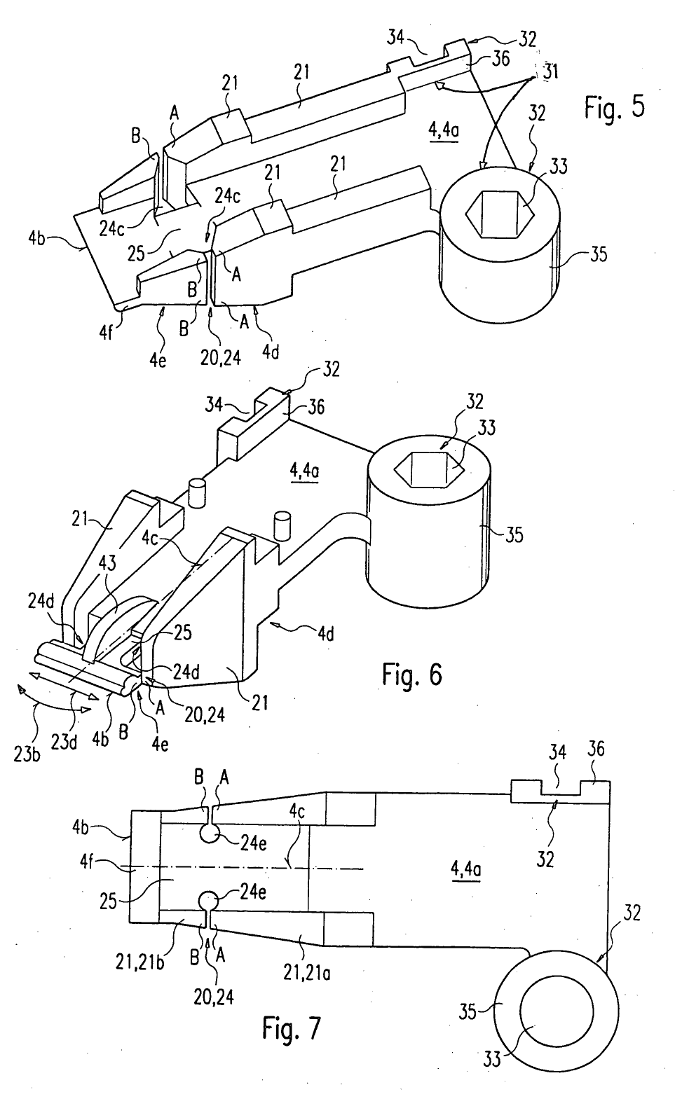

In the exemplary embodiments according to FIGS. 5 to 7, in which identical parts are referred to by identical reference numbers, an anchoring device of how the application member 4 is anchored in the housing 2 is represented, which will be briefly described in the following.

In the exemplary, embodiments according to FIGS. 5 to 7, the respective application member 4 is designed so as to be suitable for a hand-held device in which the planes of rotation of the take-up spool 13 and the supply spool 14 run parallel to the application edge 4b. That is to say that in the exemplary embodiments, or FIGS. 5 to 7, the application member 4 with its application edge 4b is arranged to be distorted by 90° with respect to the central axis 4c. This is true also for the anchoring device 31. Such a type of construction of a present hand-held device is described, for instance, in EP 0 551 522 BI. In order to avoid repetitions, full reference is made to the description and the drawings of said printed publication.

In the exemplary embodiment according to FIG. 5, the guiding webs 21 are, e.g., slightly tapered, extended, towards the interior, so that they extend into the housing 2. The cross-sectional shape of the remaining cross-section 25 is designed to be longish in the horizontal direction, whereby the vertical dimension of the remaining cross-section 25 can correspond to the thickness of the application gib 4a. The lateral convex rounded form of the remaining cross-section 25 has proved to be an advantage and has been maintained in comparison with the remaining cross-section 25 according to FIG. 3.

It is a further difference over the configuration according to FIGS. 1 to 4 that the cross-sectional reduction or the slot 24 starting at a distance from the outer lateral surfaces of the guiding webs 21 are formed divergently to the interior. Thereby, free spaces 24c have been created, which simplify, among, other things, the removing of the application member 4 preferably formed as a die-cast part from the mould.

In the exemplary embodiment according to FIGS. 1 to 4 and in the exemplary embodiment according to FIG. 5, the respective front end portion of the application gib 4a is formed as elastically bendable applicator lip 4f, whose strength is dimensioned to be large enough to be elastically bendable outwards under the pressure to be exerted on the substrate 8 manually under normal conditions of usage. In the exemplary embodiment, the thickness f of the applicator lip 4f is dimensioned to be smaller than the thickness of the application gib 4a, whereby it is preferably offset towards the bottom and is tapered with respect to the application gib 4a by a recess on top. As is revealed particularly by FIG. 2, the application edge 4d can be formed by a preferably partially cylindrically rounded portion whose radius r conforms approximately to the thickness f of the applicator lip 4f or can be larger, as shown in FIG. 2. In the exemplary embodiment, the applicator lip 4f extends in the area of length c, so that it projects from the front end of the guiding webs 21.

The anchoring device 31 is formed by a form-fit effective plug-in socket 32 with at least one plug-in recess 33, by which the application member 4 can be plugged onto at least one plug-in pin at the appertaining part of the housing transversely to the plane of the application edge 4d. In the exemplary embodiment, two lateral plug-in recesses 33, 34 are formed at the application member 4a or lateral material lugs 35, 36. The one plug-in recess 33 is formed by a plug-in hole in a formed jack in the exemplary embodiment. The other plug-in recess 34 is formed by a laterally open groove in the appertaining material lug 36. The latter is positioned between two housing halves in a form-fit fashion in a direction transversely to the longitudinal plane of the application member 4 containing the application edge 4b.

In the exemplary embodiment according to FIG. 6, the cross-sectional reduction 20 or two lateral slots 24 also extend transversely to the central axis 4c, whereby they extend backwards in an angular fashion on both sides of the remaining cross-section 25. As a result thereof, free spaces 24d are available between the remaining cross-section 25 and the guiding webs 21, which improve the flexibility of the front gib portion 4e in a lateral direction. This additional degree of freedom is identified by 23d. Even in this embodiment, the cross-sectional reduction 20 can be formed by a relatively thin slot 24, which extends in an angular fashion on both sides of the remaining cross-section 25, as seen in a top view.

The cross-sectional reduction 20 can also extend at the front end of the guiding webs 21, as shown in FIG. 6. It can be favorable to a stabilization of the front gib portion 4e to reinforce the latter by a transversely extending bead 42, which is preferably provided on top. For further reinforcement, the remaining cross-section 25 can be stabilized between the free spaces 24d by a longitudinal web 43 on top, which preferably turns into the bead 42. For further stabilization, the guiding webs 21 can be designed to be divergent towards the back, in particular divergent in a wedge-shaped fashion.

The latter is provided for also in the exemplary embodiment according to FIG. 7. In addition, said configuration differs from FIG. 5 in that the cross-sectional reduction 20 or two lateral slots 24 directed towards each other terminate inside into preferably round slot extensions 24e.

The housing 2 or the housing parts 2a, 2b, the reels 12, 13, and the application member 4 are preferably injection molded parts, especially made of plastic material, which ensure simple and inexpensive manufacture also in case of complicated shapes.

1. A hand-held device for transferring a film onto a substrate, said hand-held device comprising:
a housing configured for accommodating a film supply; and
an application member projecting from said housing along a longitudinal axis;
wherein:
said application member has at least two application member portions movable relative to each other; and
motion stops corresponding with each other are arranged at said movable application member portions, said stops bordering the relative movement between said movable application member portions.

2. A hand-held device as claimed in claim 1, wherein said motion stops include at least one pair of stops provided at an axial distance from each other.

3. A hand-held device as claimed in claim 1, wherein said motion stops include at least one pair of stops provided directed towards the peripheral direction and at a distance from each other perpendicular to said longitudinal axis.

4. A hand-held device as claimed in claim 1,
wherein said application member has an upper side, a bottom side, and side surfaces; and
at least one pair of stops is provided at at least one of said upper side, said bottom side, or said side surfaces of said application member.

5. A hand-held device as claimed in claim 1, wherein a cross-sectional reduction is provided between said movable application member portions.

6. A hand-held device as claimed in claim 5, wherein said cross-sectional reduction is constituted by a gap.

7. A hand-held device as claimed in claim 6, wherein said gap has an axial width less than 2 mm.

8. A hand-held device as claimed in claim 7, wherein said gap has an axial width less than about 1 mm.

9. A hand-held device as claimed in claim 5, wherein said application member has a remaining cross-section at a coaxial position relative to said cross-sectional reduction.

10. A hand-held device as claimed in claim 5, wherein said movable application member portions are formed by flat gibs placed one behind the other.

11. A hand-held device as claimed in claim 10, further comprising lateral webs protruding upwards and/or downwards from both sides of the said flat gibs.

12. A hand-held device as claimed in claim 11, wherein said cross-sectional reduction is provided in said lateral webs.

13. A hand-held device as claimed in claim 12, wherein said cross-sectional reduction also extends into a cross-sectional portion of said application member.

14. A hand-held device as claimed in claim 13, wherein said cross-sectional reduction extends into the sides of said application member.

15. A hand-held device as claimed in claim 12, wherein said stops are formed by at least one of upper border, lower borders, or lateral borders of said lateral webs.

16. A hand-held device as claimed in claim 11, wherein said stops are formed by at least one of upper border, lower borders, or lateral borders of said lateral webs.

17. A hand-held device as claimed in claim 1, wherein said movable application member portions are formed by flat gibs placed one behind the other.

18. A hand-held device as claimed in claim 17, further comprising lateral webs protruding upwards and/or downwards from both sides of the said flat gibs.

19. A hand-held device as claimed in claim 18, wherein a cross-sectional reduction is provided in said lateral webs.

20. A hand-held device as claimed in claim 19, wherein said cross-sectional reduction also extends into a cross-sectional portion of said application member.

21. A hand-held device as claimed in claim 18, wherein said stops are formed by at least one of upper border, lower borders, or lateral borders of said lateral webs.

22. A hand-held device as claimed in claim 1, wherein:
said application member is formed by an application gib; and
said movable application member portions are resiliently bendable and/or torsional relative to each other.
